(19) United States
(12) Patent Application Publication
(10) Pub. No.: US 2025/0057362 A1
(43) Pub. Date: Feb. 20, 2025

(54) BASE FOR MOUNTING FUNCTIONAL UNITS OF STIR-FRY DEVICE AND STIR-FRY DEVICE COMPRISING THE BASE

(71) Applicant: Shanghai Aican Robot (Group) Co., Ltd., Shanghai (CN)

(72) Inventors: Qing HE, Shanghai (CN); Guang HE, Shanghai (CN); Kun YUAN, Shanghai (CN)

(21) Appl. No.: 18/800,118

(22) Filed: Aug. 11, 2024

(30) Foreign Application Priority Data
Aug. 16, 2023 (CN) 202322206783.6

(51) Int. Cl. A47J 43/08; A47J 36/16; A47J 43/046; A47J 43/07

(52) U.S. Cl. CPC A47J 43/085; A47J 36/165; A47J 43/046; A47J 43/0722

(57) ABSTRACT

Abase for mounting functional units of a stir-fry device including: a cylindrical main body including a top surface, and a connecting cylinder. The connecting cylinder extends upwards from the center of the top surface and is configured to receive a stirring blade for stirring food materials in a frying pan. The edge of the top surface includes a plurality of spaced apart mounting holes and a plurality of spaced apart fastening holes. The frying pan is fixed on the base through the spaced apart mounting holes, and the base is fixed in an inner ring of a pivoting support of a stir-fry device through the spaced apart fastening holes. The base further includes a bottom surface including a plurality of spaced apart fixing holes, and a driven gear meshed with a driving gear is fixed on the base through the spaced apart fixing holes.

### CROSS-REFERENCE TO RELATED APPLICATIONS

Pursuant to 35 U.S.C. § 119 and the Paris Convention Treaty, this application claims foreign priority to Chinese Patent Application No. 202322206783.6 filed Aug. 16, 2023, The contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to cooking equipment, and more particularly to a base for mounting functional units of a stir-fry device and a stir-fry device comprising the base.

Conventional stir-fry devices usually include a housing, a heating coil, a frying pan, a drive motor driving the frying pan to rotate, a stirring blade, and a stirring motor. These components are interconnected through a plurality of auxiliary connecting parts, which leads to complex internal connection, low assembly precision, and low space utilization rate.

### SUMMARY

One objective of the disclosure is to provide a base for mounting functional units of a stir-fry device, so that the stir-fry device comprising the base is highly integrated and features high assembly precision.

To achieve the objective, the disclosure provides a base for mounting functional units of a stir-fry device, the stir-fry device comprising a frying pan, a driven gear, and a driving gear; the base comprising: a cylindrical main body comprising a top surface, and a connecting cylinder; the connecting cylinder extending upwards from a center of the top surface and being configured to receive a stirring blade for stirring food materials in the frying pan; an edge of the top surface comprising a plurality of spaced apart mounting holes and a plurality of spaced apart fastening holes; the frying pan being fixed on the base through the plurality of spaced apart mounting holes, and the base being fixed in an inner ring of a pivoting support of a stir-fry device through the plurality of spaced apart fastening holes; the fastening holes being disposed through the base; the base further comprising a bottom surface comprising a plurality of spaced apart fixing holes on a periphery of the bottom surface, and the driven gear which is meshed with the driving gear being fixed on the base through the plurality of spaced apart fixing holes; an opening of each of the fixing holes being on the bottom surface of the base, and a lower opening of each of the fastening holes being spaced from the bottom surface; and an outer ring of the pivoting support being fixed on a bottom part of an outer shell of the stir-fry device.

In a class of this embodiment, a periphery of the top surface of the base comprises a mounting position for mounting a temperature sensor bracket.

In a class of this embodiment, the mounting position is a recess comprising a side opening.

In a class of this embodiment, a cylindrical sealing sleeve comprising a shaft passage is connected to the connecting cylinder; the cylindrical main body comprises a central passage; a stirring shaft configured to drive the stirring blade to rotate passes through the central passage and the shaft passage in turn from bottom up to connect to a connecting seat of the stirring blade; the connecting seat is disposed on the cylindrical sealing sleeve and is rotatable with respect to the cylindrical sealing sleeve; a lower end of the stirring shaft is connected to an output end of a stirring motor disposed below the base.

The disclosure provides the base for mounting functional units of a stir-fry device. The connecting cylinder, the plurality of mounting holes, the plurality of fastening holes, the plurality of fixing holes, the positioning structure for fixing bearings for positioning the stirring shaft, the mounting position for installing the temperature sensor bracket, wire holes, and the cylindrical accommodation cavity are formed or disposed on the base. Therefore, the installation of various functional units of the stir-fry device can be realized through the single component. The design has a high degree of installation integration and simplifies the internal assembly structure of the stir-fry device, improves the assembly precision, and saves the internal space of the stir-fry device.

In another aspect, the disclosure provides a stir-fry device comprising the above-mentioned base for mounting functional units of the stir-fry device.

In a class of this embodiment, the stir-fry device further comprises a supporting base fixed on a bottom part of the outer shell of the stir-fry device; a central part of the supporting base comprises a downwardly extending support platform; an inner wall of the support platform comprises a notch, and the driven gear configured to drive the base to rotate is meshed with the driving gear disposed outside the support platform through the notch.

In a class of this embodiment, the inner wall of the support platform comprises an upper step and a lower step; the base is fixedly connected to the inner ring of the pivoting support; the outer ring of the pivoting support is disposed on the lower step; and the driven gear is disposed on the upper step and is fixedly connected to the base.

In a class of this embodiment, at least two pillars extend downward from a bottom surface of the supporting base, and a support plate is fixedly connected to lower end surfaces of the at least two pillars; and a stirring motor for driving the stirring blade to rotate and a drive motor for driving the driving gear to rotate are disposed on the support plate.

In a class of this embodiment, an adapter plate is fixed on a bottom of the inner ring and sleeves a stirring shaft of the stirring blade; an electrically conductive slip ring is fixed on a bottom of the adapter plate, and a wire of a temperature sensor passes through the base, the inner ring, and the adapter plate in turn and is connected to an outer slip ring of the electrically conductive slip ring, and a wire of an inner slip ring of the electrically conductive slip ring is connected to a main control circuit of the stir-fry device.

In a class of this embodiment, a gasket is disposed between the frying pan of the stir-fry device and the base to prevent water flowing into the stir-fry device from penetrating into the electrically conductive slip ring via the base.

The stir-fry device of the disclosure can integrate and combine all internal components through two parts, that is, the base and the supporting base, thus simplifying assembly, improving the production efficiency and assembly accuracy.

### BRIEF DESCRIPTION OF THE DRAWINGS

FIG. 1 is a top view of a base for mounting functional units of a stir-fry device in one embodiment of the disclosure;

FIG. 2 is a bottom view of a base for mounting functional units of a stir-fry device in one embodiment of the disclosure;

FIG. 3 is a sectional view of a stir-fry device in one embodiment of the disclosure;

FIG. 4 is a local enlarged view of part A in FIG. 3;

FIG. 5 is a schematic diagram of a supporting base of a stir-fry device in one embodiment of the disclosure; and

FIG. 6 is an exploded view of a stir-fry device in one embodiment of the disclosure.

In the drawings, the following reference numbers are used: 1. Base; 11. Connecting cylinder; 12. Mounting hole; 13. Fastening hole; 14. Fixing hole; 151. Convex platform; 152. Supporting sleeve; 16. Recess; 161. Connection hole; 17. Wire hole; 171. Guide opening; 18. Cylindrical accommodation cavity; 19. Central passage; 21. First step surface; 22. Second step surface; 3. Stirring blade; 31. Stirring shaft; 32; Stirring motor; 33. Gear; 4. Driven gear; 5. Pivoting support; 51. Inner ring; 52. Outer ring; 53. Adapter plate; 6. Cylindrical sealing sleeve; 61. Cylindrical part; 62. Cover part; 7. Temperature sensor bracket; 100. Stir-fry device; 10. Inner shell; 20. Outer shell; 201. Annular flange; 30. Frying pan; 40. Supporting base; 401. Top plate; 402. Upper step; 403. Lower step; 404. Notch; 405. Pillar; 50. Support plate; 60. Drive motor; 601. Driving gear; 70. Electrically conductive slip ring; 80. Support bracket.

### DETAILED DESCRIPTION

To further illustrate the disclosure, embodiments detailing a base for mounting functional units of a stir-fry device and a stir-fry device comprising the base are described below. It should be noted that the following embodiments are intended to describe and not to limit the disclosure.

The disclosure provides a base for mounting functional units of a stir-fry device. A connecting cylinder 11, a plurality of mounting holes 12, a plurality of fastening holes 13, a plurality of fixing holes 14, a positioning structure for fixing bearings for positioning a stirring shaft 31, a mounting position for installing the temperature sensor bracket 7, wire holes 17, and a cylindrical accommodation cavity 18 are formed or disposed on the base 1. Therefore, the installation of various functional units of the stir-fry device 100 can be realized through the single component, that is, the base. The design has a high degree of installation integration and simplifies the internal assembly structure of the stir-fry device 100, improves the assembly precision, and saves the internal space of the stir-fry device 100.

### 1. Base 1

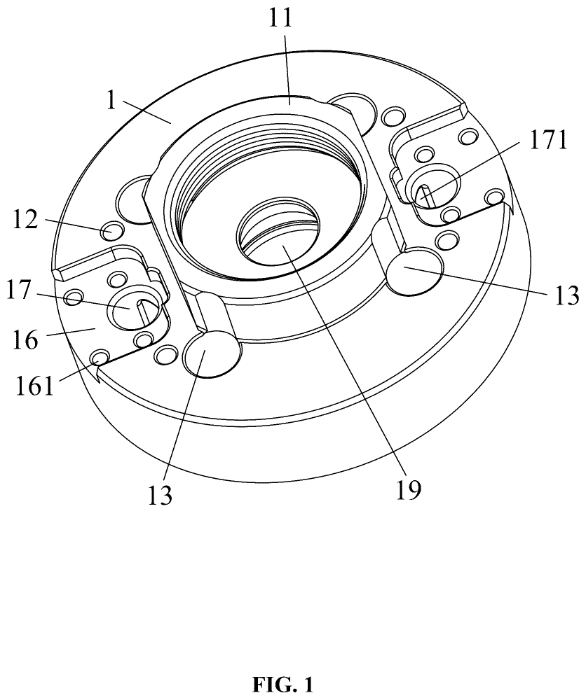

As shown in FIGS. 1-4, the base 1 comprises a cylindrical main body, which is in the form of a disk with a certain thickness.

### 1.1) Connecting Cylinder 11

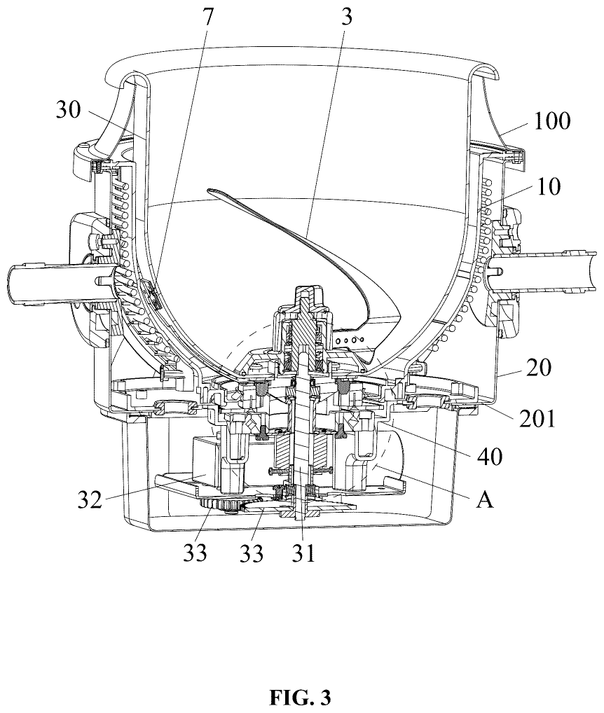

The top surface (with the front view in FIG. 3 as an example, the upper and lower directions respectively refer to the upper (top) parts and lower (bottom) parts of each unit in the stir-fry device 100) is equipped with an upward extending connecting cylinder 11 in the middle. The inner wall of the connecting cylinder 11 is an internal threaded structure, which is used to receive a stirring blade 3 for stirring the food materials in the frying pan 30.

### 1.2) Mounting Holes 12

The frying pan 30 is fixed on the base 1 through the mounting holes 12. The number of mounting holes 12 is at least two, which are spaced apart on the top surface of the periphery of the connecting cylinder 11; preferably, the mounting holes 12 are blind holes, the number of which is four.

### 1.3) Fastening Holes 13

The inner ring 51 of the pivoting support 5 is fixed on the base 1 through the fastening holes 13; preferably, the number of the fastening holes 13 is four, and all the fastening holes 13 are distributed on the top surface around the connecting cylinder 11 in a circular manner with the center axis of the base 1 as the axis; the fastening holes 13 are through holes running through the base 1 from the top to the bottom, and the upper part and the lower part of the fastening holes 13 are in the form of cylindrical shape with different diameters; the diameter of the upper part is compatible with the head size of the screws installed therein, and the diameter of the lower part is compatible with the diameter of the screws therein. The design can hide the head of the screws inside the base 1, avoiding that the head of the screw is exposed out of the top surface of the base 1, which affects the installation of the frying pan 30.

### 1.4) Fixing Holes 14

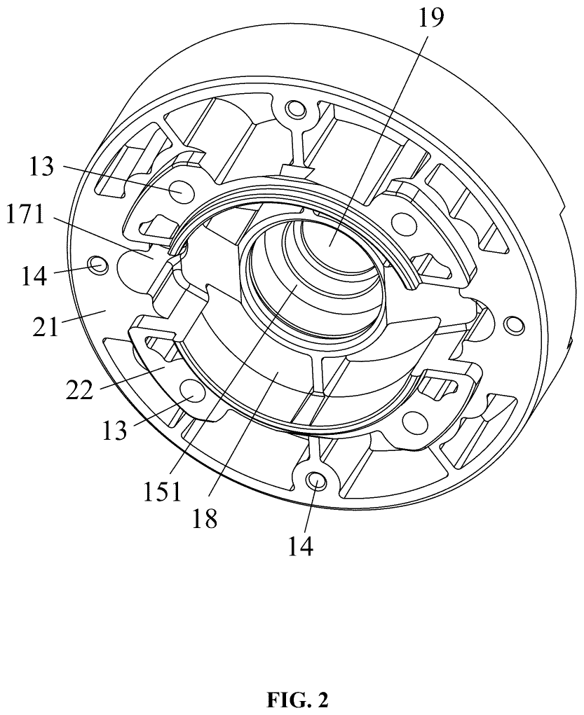

The driven gear 4 meshed with the driving gear 601 is secured to the base 1 through the fixing holes 14; at least two fixing holes are spaced apart in the outer periphery of the bottom surface of the base 1. As shown in FIG. 2, the bottom surface of the base 1 is in the shape of a step, which comprises a first step surface 21 and a second step surface 22 located in the middle of the first step surface 21 and projected downward from the first step surface 21; the fixing holes 14 are a blind hole recessed upwardly from the first step surface 21, and the fastening holes 13 run downwardly from the top surface of the base 1 to the second step surface 22, i.e., the lower end of the fastening holes 13 is lower than the lower end of the fixing holes 14.

The driven gear 4 is in the form of a circular piece, the thickness of which is less than the height from the first step surface 21 to the second step surface 22.

Thus, by designing the bottom surface of the base 1 as a step, the inner ring 51 of the pivoting support 5 is fixed on the second step surface 22 through the fastening holes 13, and then the space for installing the driven gear 4 is formed on the bottom surface of the base 1, which makes the structure compact and occupies little space.

### 1.5) Positioning Structure

As shown in FIGS. 2-4, the cylindrical main body comprises a central passage 19, and a stirring shaft 31 configured to drive the stirring blade 3 to rotate passes through the central passage 19; the central passage 19 is connected to the connecting cylinder 11 and coaxially disposed with the connecting cylinder 11.

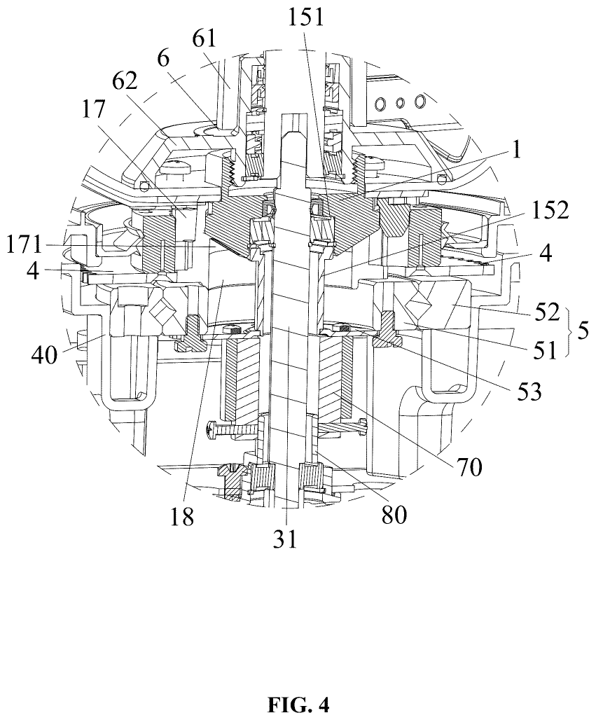

As shown in FIG. 4, the inner wall of the central passage 19 is provided with a positioning structure for installing and supporting the stirring shaft 31 and allowing the stirring shaft 31 to rotate inside the central passage 19. The positioning structure comprises a convex platform 151 disposed on the inner wall for supporting the upper surface of the outer ring of the bearing, and a supporting sleeve 152 sleeving the stirring shaft 31. The upper end of the supporting sleeve 152 is disposed in the central passage 19 to support the bearing. The lower end of the supporting sleeve 152 is connected and supported on the lower surface of the inner ring 51 of the pivoting support 5 through an adapter plate 53. The outer ring of the bearing is fixedly clamped in the central passage 19 under the action of the convex platform 151 and the supporting sleeve 152. The outer ring of the bearing, the supporting sleeve 152, the inner ring 51 of the pivoting support 5, and the base 1 all rotate synchronously.

The upper end of the stirring shaft 31 passes through the supporting sleeve, the inner ring of the bearing, and the central channel 19 in turn from bottom up and is connected to a connecting seat of the stirring blade 3 above the connecting cylinder 11. The stirring shaft 31 is fixedly connected to the inner ring of the bearing and rotates in synchronization, and the lower end of the stirring shaft 31 is connected to the output end of the stirring motor 32 disposed below the base 1. The stirring motor 32 drives the stirring shaft 31 to rotate, driving the stirring blade 3 to stir-fry the food materials inside the frying pan 30.

### 1.6) Mounting Position and Wire Holes 17

The periphery of the top surface of the base 1 comprises a mounting position for mounting a temperature sensor bracket 7. Preferably, as shown in FIG. 1, the mounting position is a recess 16 comprising a side opening. The shape of the recess 16 is adapted to the shape of the connecting portion of the temperature sensor bracket 7.

The temperature sensor bracket 7 is a strip structure extending from below upwards, with an arc-shaped longitudinal section. The connecting portion is disposed at the lower end of the temperature sensor bracket 7, and the temperature measurement sensor is disposed on the upper end of the temperature sensor bracket 7.

A connection hole 161 and a wire hole 17 are disposed on the bottom of the recess 16. The connecting portion is fixed in the connection hole, and the wires of the temperature measurement sensor pass through the wire hole 17 and extend to the lower surface of the base 1.

The design of the recessed structure on the base 1 for mounting the temperature sensor bracket 7 saves space, and the connecting portion is located in the recess 16, facilitating the fitted connection between the top surface of the base 1 and the bottom surface of the frying pan 30.

### 1.7) Cylindrical Accommodation Cavity

As shown in FIGS. 2-4, to facilitate the routing of the wires of the temperature measurement sensor, a cylindrical accommodation cavity 18 is disposed in the second step surface 22 and surrounded by the fastening holes 13, and the diameter of the cylindrical accommodation cavity is larger than the diameter of the central passage 19. The cylindrical accommodation cavity communicates with the central passage 19. A guide opening 171 is provided in the inner wall of the wire hole 17 towards the center axis of the base 1, thus enabling the wire hole 17 to communicate with the cylindrical accommodation cavity.

The cylindrical displacement cavity 18 faces the space enclosed by the inner ring 51 of the pivoting support 5 and forms a closed space with the adapter plate 53.

By designing the cylindrical displacement cavity 18 on the base 1, the internal space of the base 1 is fully utilized, and meanwhile, the route path of the wire hole 17 is shortened, the threading difficulty is reduced, and the installation space for the threaded wires is enlarged.

Preferably, the parts of the base 1 that are not occupied by physical structures are hollow, which can reduce the weight of the base 1.

Assembly relationship between the base 1 and the units are as follows:
i) Fixedly mounting the temperature sensor bracket 7 in the recess 16.
ii) the driven gear 4 is disposed on the first step surface 21 and in parallel to the first step surface, and then the screw passes through the driven gear 4 from the bottom up and is fixed in the fixing hole 14, thereby fixing the driven gear 4 on the base 1; the inner ring 51 of the pivoting support 5 is fixed on the second step surface 22 through the fastening hole 13, whereby the pivoting support 5 is connected to the base 1; there is a clearance between the bottom surface of the driven gear 4 and the top surface of the outer ring 52 of the pivoting support 5 for the free rotation of the driven gear 4, and the gear ring of the driven gear 4 extends horizontally beyond the outer peripheral wall of the base 1.
iii) The outer bottom surface of the frying pan 30 abuts against the top surface of the base 1 and the connecting cylinder 11 passes through the center hole in the bottom of the frying pan 30 and is disposed in the frying pan 30, and the screws or bolts are fixed in the mounting holes 12 downwardly from the frying pan 30 to securely attach the frying pan 30 to the base 1.
iv) The bearings of the stirring shaft 31 are installed in the positioning structure, and then the stirring shaft 31 is installed on the bearings; the installation method has been described above, and will not be repeated herein.
v) The outer ring 52 of the pivoting support 5 is fixed to the bottom of the housing 20 of the stir-fry device 100.

The frying pan 30 is supported by the upper part of the base, and the lower part of the base is connected to the pivoting support 5, so that the weight of the frying pan 30 transfer to the shell of the stir-fry device 100, and at the same time the driven gear 4 driving the frying pan 30 to rotate is fixed on the base 1; the overall connection structure is stable and stressed evenly.

### 1.8) Cylindrical Sealing Sleeve 6

A cylindrical sealing sleeve 6 comprising a shaft passage is connected to the connecting cylinder 11. The cylindrical sealing sleeve 6 comprises a cylindrical part 61 and an umbrella-shaped cover part 62 that is connected to the middle and lower peripheral wall of the cylindrical part 61 and coaxial with the cylindrical part 61. The shaft passage is formed in the cylindrical part 61. Correspondingly, the outer wall of the cylindrical part 61 in the cover part 62 is of external threaded structure.

The cylindrical part 61 is screwed in the connecting cylinder 11, whereby the cylindrical sealing sleeve 6 is connected to the connecting cylinder 11, and in this way, the outer end face of the cover part 62 is closely attached to the bottom of the frying pan 30 and a sealing ring is disposed therebetween. In this way, the screw cap for locking the frying pan 30 and the base 1 is located under the cover part 62.

The cover part 62 is configured to prevent the food materials or vegetable juices from flowing out of the frying pan 30, ensuring the hygienic use of the stir-fry device.

Amounting structure for fixing the bearing of the stirring shaft 31 is also disposed in the shaft passage; the upper end of the stirring shaft 31 penetrates the cylindrical part 61 and is connected to the connecting seat, and the drive motor 60 drives the stirring shaft 31 to rotate, and the stirring shaft 31 brings the stirring blades 3 to rotate relative to the cylindrical sealing sleeve 6.

The upper part of the stirring shaft 31 can be integrated with the stirring shaft 31, or may be a segmented extension shaft, and the segmented extension shaft can enhance the torque of the stirring shaft 31.

### 2. Stir-Fry Device 100

As shown in FIG. 3, the stir-fry device 100 comprises an inner shell 10, an outer shell 20, a supporting base 40, and the above-mentioned base 1 and fry pan 30.

### 2.1) Inner Shell 10 and Outer Shell 20

The vertical cross-section of the inner shell 10 is in the shape of an arc, which is the same as the arc shape of the vertical cross-section of the lower half of the fry pan 30. The inner shell 10 comprises a top opening and a bottom opening. The fry pan 30 is put into the cavity of the inner shell from the top opening and coaxially disposed with the inner shell 10.

The base 1 is disposed in the bottom opening of the inner shell 10, and there is a gap between the peripheral wall of the base 1 and the bottom opening, so that the base 1 can rotate freely. A sealing structure is disposed in the gap to prevent water from flowing from the gap to the electrical components below the base 1.

The outer shell 20 is wrapped around the outer side of the inner shell 10, acting as a water and oil repellent for the electromagnetic heating coils on the outer peripheral wall of the inner shell 10, and preferably, the outer shell 20 comprises a cylindrical side wall and an annular flange 201 extending inwardly along the side wall.

### 2.2) Supporting Base 40

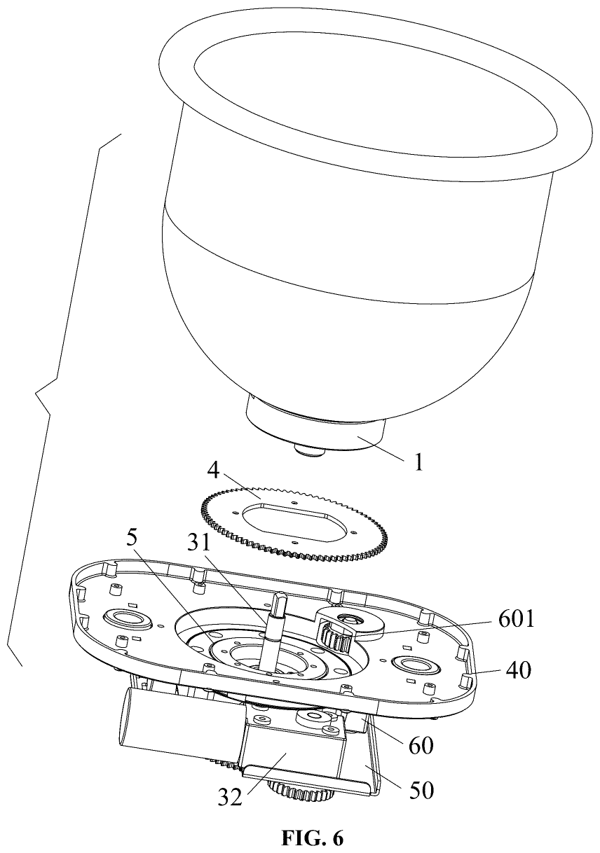

As shown in FIGS. 3-6, the supporting base 40 is configured to receive the outer ring 52 of the pivoting support 5 and to provide support for components such as the drive motor 60 disposed under the base 1.

The top plate 401 of the supporting base 40 laps over and is secured to the annular flange 201, and a cylindrical support platform extends downwardly from the center of the top plate 401. The inner wall of the support platform comprises a notch 404, and the driven gear 4 configured to drive the base 1 to rotate is meshed with the driving gear 601 disposed outside the support platform through the notch 404.

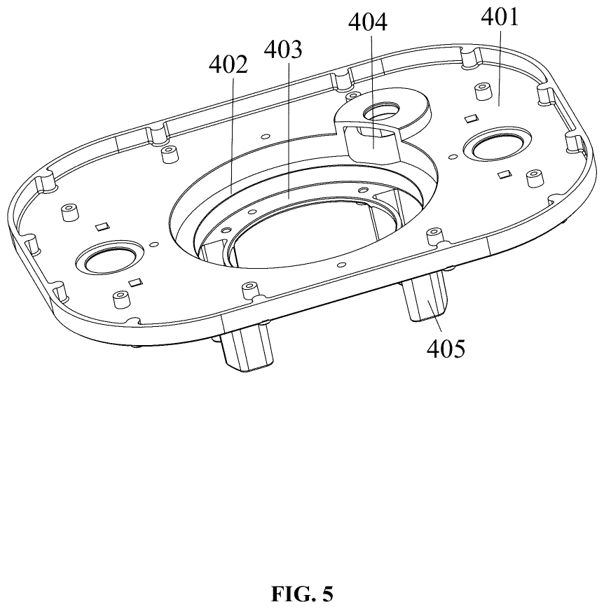

Preferably, as shown in FIG. 5, the inner wall of the support platform comprises an upper step and a lower step; the outer ring 52 of the pivoting support 5 is supported and fixed on the lower step 403; and the driven gear 4 is disposed on the upper step 402. The notch 404 is close to the surface of the upper step 402 and opposite to the gear ring.

At least two downwardly extending pillars 405 are provided along the surface of the lower step 403, and a support plate 50 is secured to the lower end surface of the pillars 405.

As shown in FIG. 3, the output shaft of the stirring motor 32, which drives the rotation of the stirring blade 3, passes downwardly through the support plate 50 and is fixed on the support plate 50; similarly, the lower end of the stirring shaft 31 extends downwardly and passes through the support plate 50 to be placed under the support plate 50. The stirring shaft 31 and the support plate 50 are rotatably connected with one another by means of bearings. Gears 33 are provided at the output shaft of the stirring motor 32 and at the lower end of the stirring shaft 31, and the two gears 33 mesh with each other in transmission.

Furthermore, an electrically conductive slip ring 70 is fixed on the bottom of the adapter plate 53; the outer slip ring of the electrically conductive slip ring 70 is fixed to the adapter plate 53 and is rotatable with the adapter plate 53 and the base 1, and the inner slip ring of the electrically conductive slip ring 70 is fixed to the support plate 50 by a support bracket 80; the wire of the temperature measurement sensor passes through the wire hole 17, the cylindrical accommodation cavity 18, the inner ring 51, and the adapter plate 53 to connect to the electrically conductive slip ring 70 in turn. The wire of the electrically conductive slip ring 70 is connected to the main control circuit of the stir-fry device 100.

The supporting base 40 bears the weight of all components of the stir-fry device 100 except the outer shell 20 and the inner shell 10, and transfers the weight to the outer shell 20. The recessed support platform supports components such as the pivoting support 5 and the base 1, leading to a compact connection of components and high space utilization. The pillars 405 provide a support point for the drive motor 60 and other components, and the integral structure of the supporting base 40 simplifies the connection and installation of the components, improves the production efficiency and the overall stability.

Furthermore, a gasket is disposed between the top surface of the base 1 and the bottom of the frying pan 30 to prevent water flowing into the stir-fry device 100 from penetrating into the electrically conductive slip ring 70 via the joint of the base 1 and the frying pan 30.

The stir-fry device 100 of the disclosure can integrate and install all internal components through two parts: the base 1 and the supporting base 40, thus simplifying assembly, improving the production efficiency and assembly accuracy.

It will be obvious to those skilled in the art that changes and modifications may be made, and therefore, the aim in the appended claims is to cover all such changes and modifications.

What is claimed is:

1. Abase for mounting functional units of a stir-fry device, the stir-fry device comprising a frying pan, a driven gear, and a driving gear; the base comprising: a cylindrical main body comprising a top surface, and a connecting cylinder; the connecting cylinder extending upwards from a center of the top surface and being configured to receive a stirring blade for stirring food materials in the frying pan; an edge of the top surface comprising a plurality of spaced apart mounting holes and a plurality of spaced apart fastening holes; the frying pan being fixed on the base through the plurality of spaced apart mounting holes, and the base being fixed in an inner ring of a pivoting support of the stir-fry device through the plurality of spaced apart fastening holes; the fastening holes being disposed through the base; the base further comprising a bottom surface comprising a plurality of spaced apart fixing holes on a periphery of the bottom surface, and the driven gear which is meshed with the driving gear being fixed on the base through the plurality of spaced apart fixing holes; an opening of each of the fixing holes being on the bottom surface of the base, and a lower opening of each of the fastening holes being spaced from the bottom surface; and an outer ring of the pivoting support being fixed on a bottom part of an outer shell of the stir-fry device.

2. The base of claim 1, wherein a periphery of the top surface of the base comprises a mounting position for mounting a temperature sensor bracket.

3. The base of claim 2, wherein the mounting position is a recess comprising a side opening.

4. The base of claim 3, wherein a cylindrical sealing sleeve comprising a shaft passage is connected to the connecting cylinder; the cylindrical main body comprises a central passage; a stirring shaft configured to drive the stirring blade to rotate passes through the central passage and the shaft passage in turn from bottom up to connect to a connecting seat of the stirring blade; the connecting seat is disposed on the cylindrical sealing sleeve and is rotatable with respect to the cylindrical sealing sleeve; and a lower end of the stirring shaft is connected to an output end of a stirring motor disposed below the base.

5. A stir-fry device, comprising the base of claim 1.

6. The stir-fry device of claim 5, further comprising a supporting base fixed on a bottom part of the outer shell of the stir-fry device, wherein a central part of the supporting base comprises a downwardly extending support platform; an inner wall of the support platform comprises a notch, and the driven gear configured to drive the base to rotate is meshed with the driving gear disposed outside the support platform through the notch.

7. The stir-fry device of claim 6, wherein the inner wall of the support platform comprises an upper step and a lower step; the base is fixedly connected to the inner ring of the pivoting support; the outer ring of the pivoting support is disposed on the lower step; and the driven gear is disposed on the upper step and is fixedly connected to the base.

8. The stir-fry device of claim 7, wherein at least two pillars extend downward from a bottom surface of the supporting base, and a support plate is fixedly connected to lower end surfaces of the at least two pillars; and a stirring motor for driving the stirring blade to rotate and a drive motor for driving the driving gear to rotate are disposed on the support plate.

9. The stir-fry device of claim 8, wherein an adapter plate is fixed on a bottom of the inner ring and sleeves a stirring shaft of the stirring blade; an electrically conductive slip ring is fixed on a bottom of the adapter plate, and a wire of a temperature sensor passes through the base, the inner ring, and the adapter plate in turn and is connected to an outer slip ring of the electrically conductive slip ring, and a wire of an inner slip ring of the electrically conductive slip ring is connected to a main control circuit of the stir-fry device.

10. The stir-fry device of claim 9, wherein a gasket is disposed between the frying pan of the stir-fry device and the base to prevent water flowing into the stir-fry device from penetrating into the electrically conductive slip ring via the base.
